(19) United States
(12) Patent Application Publication
(10) Pub. No.: US 2026/0310237 A1
(43) Pub. Date: Oct. 8, 2026

(54) Autonomous Dispatch of Fleet Vehicles

(71) Applicant: Queen's University at Kingston, Kingston (CA)

(72) Inventors: Ryan Kealey, New Berlin, WI (US); Asli Sari, Amherstview (CA); Oscar Rielo, Kingston (CA)

(21) Appl. No.: 19/489,938

(22) PCT Filed: Jun. 5, 2024
(86) PCT No.: PCT/CA2024/050754

§ 371 Date: Dec. 4, 2025

Related U.S. Application Data
(60) Provisional application No. 63/471,350, filed on Jun. 6, 2023.

(51) Int. Cl. G05D 1/698; G05D 1/225; G05D 1/644; G05D 101/00; G05D 105/05; G06Q 10/04; G06Q 10/0631

(52) U.S. Cl. CPC G05D 1/6987; G05D 1/225; G05D 1/644; G06Q 10/04; G06Q 10/0631; G05D 2101/22; G05D 2105/05

(57) ABSTRACT

A method for scheduling actions of agents in a fleet disposed in an environment comprises using data from sensors on one agent and a Q-learning algorithm to compute initial Q-values for the agent during an exploration period comprising a selected number of actions of the agent. After each action is completed a reward is calculated and used to update a Q-value of a corresponding action-state. An optimized set of Q-values for the one agent is obtained after the exploration period, and the optimized set of Q-values is applied to all the agents in the fleet. Sensor data from the agents is used to further update Q-values for agents on an ongoing basis. The environment may be, e.g., a factory, industry, processing plant, mine, construction site, military operation, or a disaster zone.

### FIELD

This invention relates to methods and systems for implementing dispatching of fleet vehicles. More specifically, the invention provides methods, systems, and software products for dynamically controlling autonomous dispatching of fleet vehicles in real time.

### BACKGROUND

Currently, the standard practice for developing a mine dispatching plan is to choose one goal to optimize and create a multistage optimization approach using linear programming (LP) or mixed integer linear programming (MILP) to create a static plan before mining commences. This method requires a substantial amount of time to set up and is computationally intensive for a computer to find a solution. If changes are made to the mining condition, it is not a quick process to create a new mine dispatching plan, and changes cause deviations from the original dispatch strategy and require operators to intervene. Thus, a major drawback of this common dispatch planning method is the rigidness of the final plan. Linear programming is a computationally heavy technique, requiring a substantial amount of time to solve. Due to the time needed to reach a solution, plans are not updated often to account for all unanticipated changes or estimates found to be inaccurate in the model. Mining is a dynamic environment where changes happen frequently, and it is not feasible for solutions developed using current practice to be updated regularly to account for every change. The static plans create delays and inefficiencies in the mining operation, resulting in increased costs. Mine dispatchers may try to mitigate the effects of the dynamic nature of mines by directing vehicles based on current mine conditions. However, by using a static model to optimize a dynamic system, optimization is difficult to achieve.

To address this problem, deep learning has been applied to mining dispatch, however, in general, it has been done with historical data of trucks, geological surveying, and mine design for an existing mine. Zhang et al. (2020) used a Deep Q-Learning Network (DQN) based on reinforcement learning (RL) with goals to increase production and deal with unplanned fleet size changes. The baseline heuristics used were shortest queue (or minimizing wait time) and smart shortest queue (or minimizing cycle time). To measure success, the baselines were compared to the DQN created in production, cycle time, and match factor for a fixed fleet size analysis. To investigate changes in fleet size, the trained DON was compared to the smart shortest queue for production levels and the fleet size was varied by plus or minus 10% of the 50 truck fleet. Although the results suggested the DQN performed better than a static model, shortcomings of that approach limit its applicability to a real-world mining operation.

### SUMMARY

According to one aspect of the invention there is provided a method for scheduling actions of a plurality of agents in a fleet, comprising: using sensors to obtain data corresponding to actions and at least one state of one or more agent in an environment and to obtain data corresponding to states of at least one variable within the environment; using a processor to receive the data and execute a Q-learning algorithm, wherein the algorithm includes:
computing and assigning initial Q-values for the one or more agent, wherein:
   an initial Q-value corresponding to each of one or more obtainable action-states and
   an initial Q-value for the at least one state of the one or more agent are assigned non-negative values; and
   an initial Q-value for an unobtainable action-state is assigned a large negative value; implementing an exploration period comprising a selected number of actions of the one or more agent, wherein after each action is completed a reward is calculated based on the at least one state of the one or more agent and the state of the at least one variable in the environment, and the reward is used to update the Q-value corresponding to the action-state; obtaining an optimized set of Q-values for the one or more agent after the exploration period; applying the optimized set of Q-values to the plurality of agents in the fleet, and using sensors to obtain data corresponding to actions and at least one state of the plurality of agents in the environment and to obtain data corresponding to states of at least one variable within the environment; and further optimizing the Q-values for the plurality of agents, wherein for each agent, after an action is completed a reward is calculated based on the at least one state of the agent and the state of the at least one variable in the environment, and the reward is used to update the Q-value corresponding to the action-state.

In one embodiment the exploration period comprises randomly selected action-states and action-states of agents.

In one embodiment an occurrence of randomly selected action-states is gradually reduced after the exploration period.

In one embodiment the occurrence of randomly selected action-states is gradually reduced according to a decay function.

In one embodiment the occurrence of randomly selected action-states is gradually reduced to a fixed probability according to the decay function.

In one embodiment the initial Q-value for an obtainable action-state and the initial Q-value for the at least one state of the agent are zero.

One embodiment comprises using a controller that communicates with the plurality of agents including receiving the sensor data from the plurality of agents and sending instructions to the plurality of agents; identifying events associated with the data and classifying the events according to relevance to a task to be performed next by an agent; and using the classifying to control sending the data to the controller.

One embodiment comprises using a controller that wirelessly communicates with the plurality of agents including receiving the sensor data from the plurality of agents and sending instructions to the plurality of agents; using separate send and receive antennas on the agents; ranking and prioritizing the instructions sent by the controller; and controlling data acquisition rates of one or more sensors of the plurality of agents.

In various embodiments the environment is selected from a factory, industry, processing plant, mine, construction site, military operation, and a disaster zone.

In various embodiments the environment is terrestrial, aerial, aquatic, marine, in space, or extra-terrestrial.

In one embodiment the environment is a mine.

In various embodiments the reward function may include one or more of maximizing productivity, minimizing wait time of agents, and optimizing maintenance of agents.

In one embodiment the reward function includes constraints imposed by traffic patterns of agents.

In various embodiments the states are one or more conditions selected from: grade of material loaded, if an agent is loaded or not, current location of an agent, next destination of an agent, maintenance condition of an agent, and number of agents moving to a same location.

According to another aspect of the invention there is provided a non-transitory computer readable media for use with a processor, the computer readable media having stored thereon instructions that direct the processor to: obtain data corresponding to actions and at least one state of one or more agent in an environment and to obtain data corresponding to states of at least one variable within the environment; execute a Q-learning algorithm, wherein the algorithm includes:
computing and assigning initial Q-values for the one or more agent, wherein:
   an initial Q-value corresponding to each of one or more obtainable action-states and
   an initial Q-value for the at least one state of the one or more agent are assigned non-negative values; and
   an initial Q-value for an unobtainable action-state is assigned a large negative value;
implementing an exploration period comprising a selected number of actions of the one or more agent, wherein after each action is completed a reward is calculated based on the at least one state of the one or more agent and the state of the at least one variable in the environment, and the reward is used to update the Q-value corresponding to the action-state; obtaining an optimized set of Q-values for the one agent after the exploration period; applying the optimized set of Q-values to the plurality of agents in the fleet, and using sensors to obtain data corresponding to actions and at least one state of the plurality of agents in the environment and to obtain data corresponding to states of at least one variable within the environment; and further optimizing the Q-values for the plurality of agents, wherein for each agent, after an action is completed a reward is calculated based on the at least one state of the agent and the state of the at least one variable in the environment, and the reward is used to update the Q-value corresponding to the action-state.

In various embodiments, the non-transitory computer readable media implements one or more features of the methods described herein.

According to another aspect of the invention there is provided a control system that implements a method for scheduling actions of a plurality of agents in a fleet, according to embodiments described herein.

According to another aspect of the invention there is provided a control system that implements a method for scheduling actions of a plurality of agents in a fleet, wherein the control system comprises at least one processor that executes the instructions stored on the non-transitory computer readable media according to embodiments described herein.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a diagram depicting a mine layout with traffic flows according to an embodiment used for testing.

FIG. 2 is a mistake plot for a single agent with no initial training, using the mine layout embodiment of FIG. 1.

FIG. 3 is a mistake plot for a single agent with two rounds of training, using the mine layout embodiment of FIG. 1.

FIG. 4 is a frequency plot of total mistakes of a single agent for three simulations (no training, one and two rounds of training), using the mine layout embodiment of FIG. 1.

FIG. 5 is mistake plot for three agents with no initial training, using the mine layout embodiment of FIG. 1.

FIG. 6 is a frequency plot of total mistakes for three agents without training and with initial training, using the mine layout embodiment of FIG. 1.

FIG. 7 is a mistake plot for three agents with initial training, using the mine layout embodiment of FIG. 1.

FIG. 8 is a frequency plot of total mistakes for three agents with initial training, using the mine layout embodiment of FIG. 1.

FIG. 9 is a maintenance plot of a single agent (Jackal 1) with no initial training, using the mine layout embodiment of FIG. 1.

FIG. 10 is a maintenance plot of a single agent (Jackal 1) with initial training, using the mine layout embodiment of FIG. 1.

FIG. 11 is a delivery frequency plot of correctly delivered payloads for three agents with initial single agent training, using the mine layout embodiment of FIG. 1.

### DETAILED DESCRIPTION OF EMBODIMENTS

According to a broad aspect, the invention provides methods and software products that dynamically control autonomous dispatching of fleet vehicles (i.e., agents) in real time by adapting to changing environmental and operational conditions. Embodiments described herein use data corresponding to actions of two or more agents in an environment and data corresponding to states of at least one variable within the environment as inputs to a machine learning algorithm and generate outputs that are used to control actions of the agents in the environment.

For the purpose of this description, and without intending to limit the scope of the invention, embodiments will be described as applied to a mining dispatch operation. Also, embodiments using machine learning, specifically reinforcement learning as a form of machine learning, will be described. However, it will be apparent that the invention is not limited thereto, as it may be applied to other applications where autonomous dynamic real-time dispatching of fleet vehicles may be desired. Examples include, but are not limited to, factories, industries, processing plants, mines, construction sites, military operations, disaster zones, etc. Environments may be terrestrial (surface and/or below surface), aerial, aquatic or marine (surface and/or below surface), and in space or extra-terrestrial.

Mine dispatch is a complex system which, prior to the invention, is typically handled manually based on mine plans and monitored conditions at the mine. A significant drawback of such mine plans is that they are rigid and hence cannot easily and quickly respond to changing conditions whether related to agents (e.g., mining vehicles, “trucks”, etc.) and/or, for example, the state of some variable of the mine. Furthermore, responding usually requires personnel to intervene and manually change the plan.

Embodiments described herein overcome these drawbacks by providing a dynamic dispatching system that is more flexible than prior approaches and automates dispatching to increase productivity and efficiency. In the example of a mine, a dispatch system according to one embodiment may control agent actions by using agent actions or states selected from, but not limited to, material delivery, agent queues, and agent maintenance schedules across the mine under changing environmental and operational conditions; grade or classification of material loaded, if the agent is loaded or not, the current location of the agent in the environment, the next destination of the agent, the maintenance condition of the agent, and the number of agents driving to the same location. In particular, such a realistic approach addresses the dynamic nature of mining.

Whereas Zhang et al. (2020) proposed addressing shortcomings of conventional mine dispatching using a Deep Q-Learning Network (DQN) based on reinforcement learning (RL) with goals to increase production and deal with unplanned fleet size changes in a mining application, there were significant drawbacks in the simple approach used. For example, the model was based on a discrete event simulator, such that testing was not done in real-time. Instead, an over-arching system stored, created, and managed all the data used. It also did not address the level of autonomy of the vehicles, was prone to errors in the expected wait times, and it only considered shovel to dump trajectories for vehicles. The model neglected to address other vehicle dispatching dynamics such as maintenance needs, traffic patterns, and differentiation between ore and waste at dump sites. As such, that approach lacked many elements that would be relevant in an actual mine.

In contrast, embodiments described herein are based on real hardware and they apply realistic dynamics and realistic chance scenarios that affect dispatching. Embodiments demonstrate that a reinforcement learning algorithm such as Q-Learning may be implemented to effectively manage a fleet of agents and to optimize actions of agents without human direction, and it can be applied to real hardware with real-time network communication. Embodiments may employ a two-step training approach wherein the learning tasks for the algorithm may be simplified, thereby decreasing training time and improving final performance. Embodiments may be applied to autonomous or to non-autonomous systems with similar functional benefits.

As used herein, the term “agent” refers to a machine, vehicle (which may be manned, unmanned, autonomous, etc.), agent, etc., that carries out one or more actions in an environment, wherein at least one action is controlled according to embodiments described herein. An agent may be simulated or real. Two or more agents deployed in an environment may be referred to as a “fleet”.

As used herein, the term “environment” refers to a 2-D or 3-D space within which agents may be deployed to carry out actions.

As used herein, the term “plurality” means two or more.

As used herein, the term “computer” refers to any electronic device or apparatus that can receive structured input, process the structured input according to prescribed sequence or logical operations (i.e., software) automatically, and produce a result of processed information as output. The term “computer” may refer to a general purpose computer, supercomputer, mini-computer, mainframe, work-station, server, microcomputer, laptop computer, interactive television, smartphone, tablet, as well as to a device such as a central processing unit (CPU), application specific hardware (e.g., an application specific integrated circuit (ASIC)), microcontroller unit (MCU), field programmable gate array (FPGA), programmable logic device (PLD), etc. The term “computer” may also refer to two or more computers connected over a network to receive structured input, process the input information, and produce output.

As used herein, the term “software” refers to computer code or computer program or prescribed instructions that instruct a computer what to do or how to operate. Software may be stored on non-volatile computer readable media. Software may be implemented in an application (APP) and executed by a processor of a computer. Software may be written in any suitable programming language and compiled in a machine language code compatible with the processor.

In general, embodiments generate outputs (e.g., control signals) that are used to control one or more actions of agents directly. The outputs are derived through a machine learning algorithm implemented on a computer, based on receiving inputs including sensor signals from the agents and sensor signals corresponding to one or more states of the environment. Agents may be provided with one or more sensors selected from, but not limited to, LiDAR, radar, wheel encoder, magnetometer, accelerometer, inclinometer, gyroscope, inertial measurement unit (IMU), global positioning system (GPS), camera (optical and/or infra-red, etc.), proximity sensor, and the like. Sensors may also be disposed in the environment in which the agents operate, at starting points, end points/destinations of the agents, to obtain sensor signals indicative of environmental conditions and to obtain further information about location and action of agents. The selection of the types and numbers of sensors used may depend upon the application/scenario and the environment in which the agents are carrying out actions, and whether or not the agents operate autonomously in the environment. The sensor(s) provide sensor signals that may be processed, conditioned, filtered, averaged, etc. prior to use as inputs to the algorithm. Agents are also equipped with communications hardware and software that allows communication between agents and with a base station. Communication may be implemented over any of various types of networks such as, but not limited to, those based on WiFi, global system for mobile communications (GSM), code-division multiple access (CDMA), long term evolution (LTE), etc.

A control signal may determine the next action to be completed by an agent in an environment, taking into consideration current actions of other agents in the environment, the current state of the agent, and one or more current states of the environment, so that an overall operation of the agents is optimized for a performance goal (e.g., efficiency, productivity, speed of production or completion, maximum output, etc.). Embodiments continuously optimize performance in real time and determine appropriate actions for each agent in a fleet to achieve a desired goal. Embodiments are particularly suited to implementation with autonomous agent fleets, although they are not limited thereto as they can be used with any fleet of agents, including conventional, remote operated, or autonomous agents.

As demonstrated herein, reinforcement learning such as a Q-Learning algorithm may be applied to a fleet of robotic agents to solve a complex dispatching problem in real-time. The Q-Learning approach is versatile and flexible, being capable of adapting to many different scenarios without needing interruption or reconfiguring. For example, the ability of the Q-Learning algorithm to dynamically update and adapt the model based on environmental conditions allowed it to learn and improve performance over time. Although a simplified mine design was used as an example, embodiments may be configured for any mine design. Moreover, embodiments may be adapted for other applications using fleet vehicles by determining traffic patterns and relevant states and actions, and assigning Q-table action-state pair starting values.

Standard Q-table action state pairs operate in a two-dimensional space. In contrast, embodiments described herein operate according to methods that require a complex multi-dimensional space (i.e., more than two dimensions) to represent different combinations of all action state pairs. Each dimension represents a different combination of states and actions, allowing the agent to develop a more detailed understanding about its environment and an increased number of choices at any point. Adding additional dimensions increases the overall complexity and specificity of the learning model; adding new measurements, relationships, observations, and combinations of events not able to be represented in a standard two-dimensional Q-table. Over time, the additional dimensions lead to new patterns emerging in relation to past experiences, which affects future choices made by an agent automatically.

Embodiments may include assigning action-state pairs that are unobtainable to a large negative value or negative infinity. Using negative infinity for specific action-state pairs ensures that traffic patterns are correctly followed. If a new map is being built from an existing map, a pretrained Q-table may be used with additional dimensions added to represent new states. A similar approach was used in the example presented herein by expanding from single agent tests to trained multi-agent tests. The flexibility also allows for scaling the model, for example, adding more agents, whether real or simulated. For the Q-table to accommodate such a change, new dimensions may be added to represent new states that had not existed previously, making new relationships between actions and states that may have not existed before. When new dimensions are added an update to the reward function must also be made to express performance of new combinations relative to the desired goal of the system. Adding new dimensions allows the knowledge of the system to adapt to changes over time and evolve to match the changing environment. However, it is important to note that an agent's knowledge is limited by what is represented in the Q-table. Anything outside the bounds or within reasonable extrapolation of action state pairs is unknowable to the agent. Limitations to how many agents may be added may be, for example, access to equipment, computing power, network load, and testing environment space.

As demonstrated herein, a Q-table may be transferred to one or more other agent. This may be advantageous in setting up the model. Also, since over time one agent might begin to perform better than the others, the Q-table of the agent performing the best may be installed for the other agents, such that all agents can then operate as if they had the same experiences and knowledge as the top-performing agent. This is a powerful asset for an application such as mining because every piece of machinery can be operated as if it was the most skilled. It also allows fleet sizes to change naturally over time with no consequences to past training knowledge. The new agents can be added and then given the best performance immediately before beginning production, and all the other agents will adapt accordingly. Agents can also be removed from the fleet without needing to make any adjustments to the algorithm or other agents.

### Implementation

Embodiments may be implemented at least in part in computer code executable by a computer or network of computers. Such computer may include a non-transitory computer-readable storage medium, i.e., storage hardware, non-transitory storage device, or non-transitory computer system memory, etc., having stored thereon the computer code, i.e., computer-executable instructions, software, computer program, an application (“APP”), etc. that may be accessed and executed by a controller, microcontroller, processor, microprocessor, etc., of the computer. Accessing the computer-readable medium may include the computer retrieving and/or executing the computer-executable instructions encoded on the medium, which may include the processor running the app on the computer. The non-transitory computer-readable medium may include, but is not limited to, one or more types of hardware memory, non-transitory tangible media (for example, one or more magnetic storage disks, one or more optical disks, one or more USB flash drives), computer system memory or random access memory (such as, DRAM, SRAM, EDO RAM) and the like. Executing the stored instructions may enable the computer to carry out processing steps in accordance with embodiments described herein, for example, processing steps corresponding to a reinforcement learning algorithm such as a Q-Learning algorithm.

Thus, also provided herein is programmed media for use with a computer, wherein the programmed media includes computer code stored on non-transitory computer readable storage media compatible with the computer, the computer code containing instructions to direct the computer to carry out processing steps in accordance with embodiments described herein, for example, processing steps corresponding to a reinforcement learning algorithm such as a Q-Learning algorithm.

The invention will be further described by way of the following non-limiting example.

### EXAMPLE

This example demonstrates the effectiveness of an embodiment applied to a mining operation using a fully autonomous fleet of agents (i.e., vehicles). Autonomous vehicles were used because of their increased reliability and repeatability relative to non-autonomous vehicles, and they avoid the need for personnel to operate vehicles. Importantly, this demonstration involved the use of actual hardware for an agent rather than all agents being simulated, which provided a more realistic scenario.

### Agents

Robotic agents representing haul trucks were implemented using a Jackal robot (Clearpath Robotics Inc., Kitchener, ON, Canada) and Robot Operating System (ROS), Melodic Morenia version. ROS is an open-source middleware that allows for communication between hardware and software, and it has built-in physics simulation (Gazebo) and live robot monitoring (Aguero et al., 2015; Koenig et al., 2004). The ROS platform also allows a user to write programs in a multitude of languages to create ROS nodes for the aforementioned communication. These nodes communicate by sending messages to each other using specific topics. Each robot was equipped with sensors to localize it in its environments and operate autonomously, including two-dimensional LiDAR, wheel encoders, and IMUs. GPS was not used since all testing was done indoors and satellite reception was not reliable for localization. A camera was not used as it was not needed for this application. The sensor readings were filtered using an Extended Kalman Filter (EKF) to approximate location using the open-source ROS package AMCL (Adaptive Monte-Carlo Localization) (Moore et al., 2016). Before starting localization, the testing environment was mapped using an open-source software package (Gmapping; see ROS.org/gmapping). The map was recorded and saved as a two-dimensional point cloud and used as the main reference point in localization for scan matching against the LiDAR scans.

One actual Jackal robot (Jackal 1) and two Gazebo simulated Jackal robots (Gazebo 1 and 2) with matching environment configurations were used as the agents for the experiments. One simulation was run on a central computer running the real robot, and one simulation was run on a separate computer. Although two agents were simulated, the algorithm was not able to distinguish between the real and simulated agents. Running an exact simulation instead of a purely mathematical simulation is one of the many benefits of using ROS. This allowed for multiple agents to be tested without having to change the code and future work with additional real agents is seamless.

One of the simulated agents (Gazebo 2) was slightly modified to model a truck of different specifications than the others to make the scenario more realistic. It was modified to be an older and slower vehicle by reducing the agent's top speed and using slower network communications and larger localization tolerances. By having a heterogeneous fleet, a more robust solution was achieved.

In practice, it was found that none of the agents were able to perform an action in a consistent period of time due to network communication delays and localization estimation errors. The virtual agents also had ideal operating conditions that differed from the real agent, contributing to inconsistencies in action completion time. Therefore, a time step or period was considered as one move from one location to another. The number of periods completed by each agent depends on configuration parameters and how well each computer could process the data.

To model maintenance of the trucks, each agent was given a health metric to signify when maintenance is needed. Each agent started with a maximum health of 100. After each period, every agent lost 0.5 health with an increasing chance of losing an additional 5 health to simulate wear. The chance event of losing more health was used to model unpredictable scenarios that a haul truck may encounter, e.g., a window getting damaged from a rock, increased wear on tires from driving over an unexpected object or road condition, a non-crucial component breaking unexpectedly, etc. To determine the maintenance component of the reward, four states were created based on the health metric: less than 100 but greater than or equal to 50; less than 50 but greater than or equal to 30; less than 30 but greater than or equal to 0; and below 0. To calculate maintenance KPIs it was assumed that a repair takes four periods to complete based on the number of periods passed before production becomes a priority again. KPI analysis was the only time repairs were represented in this fashion.

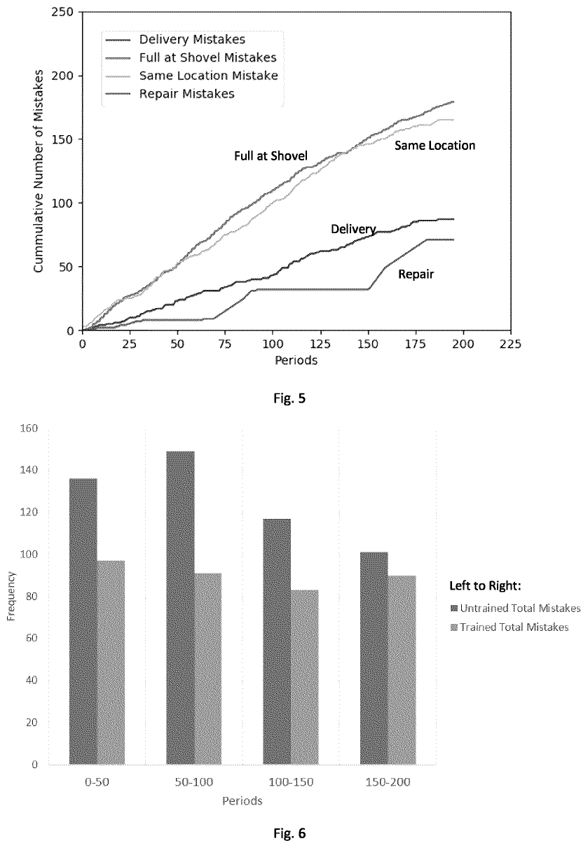

To get repaired, a truck must drive to the garage location, as shown in FIG. 5. When a truck arrived at the garage its health was replenished regardless of its health when it arrived. A reward or punishment was awarded based on the maintenance state when a truck arrived at the garage. State 1 had a punishment of −150, state 2 had a punishment of −100, state 3 had a reward of 100, state 4 had both a reward and punishment associated with it; a reward of 100 was given when the truck was repaired and had a punishment of −100 for every period that the truck was driven with a negative health value. State 3 was considered the ideal scheduled maintenance range for training the algorithm. It is important to note that in some cases, it was unavoidable to enter state 4 due to the increased probability of random health loss and trucks having to follow the rules of the road. For example, a truck with health state 5 may try to avoid a queue at the garage and instead try to deliver one last payload, but health is randomly lost at the mill. If health was not randomly lost, the truck would have been able to get repaired at health state 2.5 and been within the ideal range as it originally planned, but since health was randomly lost, it is forced into the negative range by the time it can get to the garage.

### Test Environment

A test environment was constructed in the laboratory. The environment was approximately six by six meters, utilizing two walls and two barriers to contain the Jackal robots and to ensure smooth walls for localization. An identical environment was made for simulation in Gazebo. The simulation using the Gazebo environment was used to refine and test the algorithm before using it on the real robots. Since Gazebo fully integrates into ROS, scripts written to be used on the robots can be used seamlessly with Gazebo. This allows accurate simulations with the same software intended for deployment on real hardware. Laptop computers (Lenovo ThinkPad with an Intel i5 processor and 8 Gb of RAM and Dell G7 with an Intel i7 processor and 16 Gb of RAM) were used to run the algorithm using Ubuntu 18.04. If model were to be deployed on an industrial scale system (or, e.g., using more agents), more computing power would be needed for Q-Learning to use.

### Map

FIG. 1 is a diagram of the testing environment. This layout was constructed to model a small open pit mining operation with multiple shovels and ramps to allow for multiple choices at multiple locations. In the diagram, the arrows represent the possible traffic flow of agents after reaching each location. Agents must move to a new location for every action; staying in one location is not possible. These traffic flows cannot be modified and must be strictly followed by the agent. This means that not every state combination is possible. Table 1 shows how the environment and agent interact at each location in the mine.

TABLE 1
Locations and Interactions

| Location | Interaction |
|---|---|
| Ramps | Provides access to other parts of the mine. Ramp main is also the starting initializing |
| | position for all trucks |
| Shovels | Shovels is where the trucks receive material when empty. Material classification is also |
| | performed here. There is a 50% chance of the material being ore and a 50% chance of |
| | the material being waste. If it is empty on arrival a reward is assigned. If a truck arrives |
| | here with a full bed it receives a penalty. |
| Mill and Dump | Dumping locations for trucks. A reward is given if ore is brought to the mill or waste is |
| | brought to the dump. A penalty is given if waste is brought to the mill or ore to the |
| | dump. |
| Garage | Where maintenance on trucks is performed. Depending on the repair state of the truck |
| | either a reward or punishment will be given. Maintenance level also has a random |
| | chance of degradation to account for scenarios like driving over a pothole or debris |
| | impacting the vehicle as an example. |

### Agent Localization and Extended Kalman Filter

Agent localization is the process that a mobile agent uses to estimate its position in its environment. Agent localization was achieved by using the open-source ROS package robot_localization, which uses an EKF for vehicle state estimation (Moore et al., 2016). Since navigation of the agent was only performed indoors, the GPS was not included in the EKF. The EKF fused linear acceleration values from the wheel encoders, angular position and angular velocity measured by the IMU, and the pose estimate from the LiDAR measurements calculated with Adaptive Monte-Carlo Localization (AMCL) to create a reliable estimate of the agent's position. The virtual Gazebo agents used an identical configuration in simulation to ensure all three agents localized in the same fashion.

### Measured States

As described herein, states may be measurements that are taken from the external environment as well as measurements from the state of the agent. In this example, states measured were the grade of loaded material, if the agent is loaded or not, the current location of the agent in the environment, the next destination of the agent, the maintenance condition of the agent, and the number of agents driving to the same location. This is not an exhaustive list as other states and/or different states may be used. Having many different possible states creates a dimensionally complex state space. However, by having an intricate Q-table agents have a more accurate understanding of their environment, allowing for dynamic changes to the dispatching plan based upon all the considered environmental states. It is noteworthy that in prior approaches it is possible for the agent to take any action at each time step, which may result in impossible states or undesirable states that impart negative or poor outcomes. In contrast to such prior approaches, embodiments presented herein avoid this drawback by requiring the agents to follow specified states, such as a traffic pattern (e.g., as presented in FIG. 1). As described herein, this may be achieved by assigning infinitely negative values to impossible states when initializing the Q-table to prevent the traffic pattern from being violated. This prevented an agent from wasting exploration period actions on impossible combinations as negative infinity will never be a maximum. It also reduced the dimensional computation of the Q-table because many action-state pairs were unobtainable.

### Q-Learning Model

The Q-Learning model and exploration decay policy for solution that were used in this example are shown in Equations (1) and (2), respectively. Table 2 provides definitions of variables used in the model and Table 3 provides definitions of terms in the reward function.

$$New Q ( I , g , p , d , r , n ] = Q ( I , g , p , d , r , n ] + {α}_{t} [ reward + γ max Q ] I , g , p , dt + 1 , r , n ) - Q ( I , g , p , d , r , n ) ] \qquad ( 1 )$$

$$π = 1.2 * {0.98}^{t} while t <= 88 , otherwise , π = 0.2 \qquad ( 2 )$$

TABLE 2
Variable Definitions for Q-Learning Model

| Term | Definition |
|---|---|
| Q(i, g, p, | The calculated Q-value on the Q-table where i is current location index, g is grade |
| d, r, n) | of material index, p is payload index, d is next destination index, r is maintenance |
| | state index, n is the number of agents going to same location index |
| t | Period number |
| γ | Discount Factor, value of 0.1 used |
| δ | Reward Discount Factor, value of 1.1 used |
| αₜ | Learning Rate at period t. 0.25 used for single agent, 0.80 used for multi-agent |
| M, D | Number of moves until mill or dump, respectively, from current location |
| σ | Full at shovel penalty, value of −30 when truck is full, 0 when truck is empty |
| G | Grade (−15 -oolean): 0 is waste, 1 is ore |
| R, Rₘ, R_{f} | Default reward value of 200, Default maintenance reward value of 10, Fill reward |
| | value of 50 |
| T | Truck Fill (−15 -oolean): 1 truck is empty, 0 truck is full |
| ρ | At shovel (−15 -oolean): 1 truck is at the shovel, 0 truck is elsewhere |
| Mₛ | Maintenance state based upon when repairs are performed based upon scheduling: |
| | 1 is very early, 2 is early, 3 is on time, 0 is late |
| B, Bₑ | Late repair penalty value is −100 when health is negative, otherwise 0. Repair early |
| | penalty is 0 until repairs are performed. When Mₛ = 1 penalty is −150, when Mₛ = 2 |
| | penalty is −100, when Mₛ = 3 or 0 reward is 100 |
| P | Number of increased exploration periods |
| π | Exploration policy function at period t. π = 1.2 * 0.98^{t}, after P periods π = 0.2, |
| | representing how likely a random move is to occur |

TABLE 3
Reward Function Breakdown

| Reward Component | Explanation |
|---|---|
| $[ ( \frac{R}{1 + {δ}^{M}} - \frac{R}{1 + {δ}^{D}} ) * G ]$ | Determines award or punishment for moving closer to a drop off point with a full load |
| ρ * (σ + (T * R_{f} )) | Provides reward for filling an empty truck at a shovel and punishes a full |
| | truck driving back to the shovels |
| R_{z} | Drive to ramp main reward, 200 if repairs are needed, −100 awarded upon |
| | arrival otherwise 0 |
| L | Drive to same location as other agent penalty, value of −50 per additional |
| | agent at the same location |
| ${M}_{s} * {R}_{m}^{{M}_{s}} + B + {B}_{e}$ | The reward calculated based on maintenance state when repaired or penalty for continued driving after missing scheduled maintenance |

Components presented in Table 3 may be summed to create the reward function. After an action is completed by an agent, a reward is calculated based on the environmental conditions and then using Equation 1 the specific Q-value in the Q-table is updated to reflect the relative correctness of the performed action. By having each move update the Q-table, dynamic plan updating becomes possible because future actions rewards can be accurately predicted.

The reward function includes several sub-functions and variables, as seen in Table 3, that represent cost-inducing scenarios that are specific to the application of this example, a mine. For Q-Learning, the goal is to receive as many rewards as possible to achieve optimization. In this model, the reward function is set up in a way to maximize the production, minimize the wait times and optimize the maintenance schedules, while respecting the constraints imposed by the road traffic rules. Each component of the reward function can be seen as a mixture of a constraint and sub-objective function. These sub-objectives and constraints are balanced with empirically defined scalars. Since Q-Learning can dynamically plan and adapt as the environment changes, as opposed to how prior approaches based on linear programming (LP) and mixed integer linear programming (MILP) create a static plan before mining commences, Q-Learning provides a more flexible multi-optimal approach.

Equation (2) is the decay equation of the exploration policy. According to this function more random choices are made earlier in the process, allowing exploration to occur, and the randomness slowly tapers off to a fixed probability. Equation (2) was determined empirically based upon the average number of periods completed by the real robot, how quickly the learning effect was able to be observed, and general fleet performance. For example, in one implementation 88 periods was empirically determined to be a suitable number of exploration periods. The exploration rate never decreases to zero because, for example, the environment may change, and exploration needs to occur to achieve the new optimum. This provides the ability for the agent to continue learning and handle changes in its environment on its own.

The values presented in Tables 2 and 3 used in the model and the reward function were derived empirically. Initially, values for the learning rate y and exploration policy were based upon examples presented by Sutton and Barton (2018). As the model developed, the values were tuned to achieve better performance. The reward values were determined empirically based on the relative correctness of each action taken at a specific state. Maintenance state values were created to discretize the continuous nature of the vehicle health parameter so that health could be more easily represented in the Q-table and not add an excessive number of states.

### Experimental Process

### Single Agent Baseline

For initial single agent training, the simulator was used with random payload grade assignment at the shovel, starting with an untrained model. Single agent training was done to create a baseline dispatching model that could be used on each agent in the fleet without real-world test conditions. It was also done to break down the problem for the algorithm into smaller parts. The single agent baseline was used to teach the model how to navigate the mine properly, deliver payloads to the proper location, and manage repairs without having to consider queues. To increase the robustness of the baseline model, the exploration period was reset for each run to have as much exploration time as possible. Since this testing was done in simulation, time and monitoring for safety were not considerations, allowing for prolonged test duration not possible on the real robot. Simulated testing created a robust baseline for the full system to start from that would have been more challenging to obtain using the real robot. By starting with a single agent, the Q-table was able to remove the dimensions necessary for the full system, allowing for a more complete exploration of the section of the table available.

### Multi-Agent Testing

For multi-agent testing, the Jackal robot and the two Gazebo simulations were used as a three agent fleet using an open source ROS package Multi-Master-fkie (ROS.org, Alexander Tiderko; Hernandez et al., 2015). First, a completely untrained example test was performed as a control experiment. All three agents were provided with the initial single trained simulation model with added untrained dimensions for other agent locations. Using the prior experience from the single agent, the fleet was able to focus on reducing queues at each location instead of attempting the entire problem at once. The fleet had two identical agent configurations and one that was different. In this experiment, the agents named Gazebo 1 and Jackal 1 were identical, and the agent named Gazebo 2 was of a different configuration, wherein one difference was a slower speed. This was done to mimic a real-world scenario where haul trucks with different capabilities and specifications may be part of the same fleet. Having different agents also creates a more robust model as there are more chance scenarios experienced by each agent and the whole system to learn from.

### Communications Hardware and Software

In one embodiment communication software was implemented with Multi-Master-fkie and allowed multiple ROS master nodes to communicate with each other using new or existing topics as if they were regular ROS nodes. A ROS master node monitors and manages all communications between nodes operating under it. Generally, ROS master nodes are self-contained and unable to communicate with other master nodes. Multi-Master-fkie creates an external ROS master node that is able to listen to specific topics inside other master nodes and communicates that information across a network to all the connected master nodes. Using a multi-computer ROS network case, all three agents were able to communicate across the local Wi-Fi network in the laboratory in real time. Each agent communicated its arrival status of its current action and the location of its current destination to the other two agents. This information was used to determine if another agent was driving to the same location to input into the reward function and properly index the new Q-value for the Q-table.

The high level interactivity and data rate between agents and wireless receivers didn't allow efficient bi-directional communication and created truncated packages or packet drops of data sent between agents and the controller (implemented with a computer). Packet drops cause loss of sensor data between agent and controller, and the resulting truncated streams cause misinterpretation of data from the sensors (e.g., encoders, LiDAR, GPS, etc.). Consequently, the controller receives incomplete map data or positioning data, leading to problems such as miscalculation of positional offsets (e.g., absolute position |P| vs change in position AP), which causes the agent to receive incorrect commands and results in collisions.

To address these issues the problem of truncated code received by the controller was corrected, which allowed the controller to receive all sensor data and produce accurate commands. In one embodiment, this was achieved by adjusting the sampling rate of one or more sensors by creating global instructions connected to an event identifier and de-clogging data to be streamed depending on an agent's activity, referred to herein as adaptive discrete acquisition. This was implemented in computer code running on the controller. According to one embodiment, events were classified according to dynamicity and rationalizing events, and information was ranked by importance to the task to be performed next by the agent. The events were analyzed before streaming with the objective of sending sufficient sensor measurement data to the controller for a given event according to its classification, thereby avoiding overloading the controller with excess sensor data. By receiving less but sufficient data the controller can process the information faster and send corrective commands sooner.

In addition, there was a challenge sending commands to an agent while receiving data from the agent at the same time, e.g., simultaneously. To address this challenge a communications protocol was developed that ensured there was sufficient room on the wireless data stream for sending and receiving operations. No modification was needed at the controller because the router enabled continuous streaming (e.g., using multiple single purpose antennas).

For example, in a typical scenario the controller sends commands to agents (e.g., relating to speed, heading, etc.), and requests status and data from agents that provides information used to make decisions that dictate a next action. Agents provide sensor information to the controller in order to receive the next instruction. However, bi-directional traffic on the wireless network can saturate the agents' buffers and becomes unsustainable as there is insufficient time to receive new instructions or send complete data packages to the controller. As a result, the controller may miss important data from sensors and may send incomplete instructions to agents, such that spatial information becomes unreliable, and agents progressively make mistakes, have accidents, or disconnect from the network.

In one embodiment this problem was addressed by implementing a communications strategy wherein agents acquire sensor information (i.e., data) and adjust the sensor sampling rate based on discrete events. For example, while an agent is driving, LiDAR data is collected at a higher rate in order to avoid obstacles, and at a lower rate while the agent is static. The adjustment of sampling reduces the amount of data sent from agents to the controller, ensuring there is sufficient space (i.e., bandwidth) on the wireless network for a faster exchange. Further, an agent's radios may be originally set to work as transceivers sending and receiving information asynchronously. However, according to embodiments, the radios may be reconfigured for more efficient communications. For example, antennas may be repurposed, wherein a first antenna is configured as send only (“TX”) and a second antenna is configured as receive only (“RX”). This configuration provides dedicated transmission so that data can be sent and received simultaneously without disruption. Also, according to embodiments, byte identifiers may be used, so that instructions sent by the controller may be ranked, allowing prioritization of driving commands and requests for discrete acquisition rates from agents' sensors. Traffic between router and controller remains unchanged, since there are no control commands to be verified and the agents verify that the commands are completed.

### Non-Learning Model Comparison

A simulated fleet with a predetermined dispatching plan was created according to a conventional non-learning approach (i.e., “baseline” experiment) to compare with the final Q-Learning model. A schedule based on conventional industry standards was made to be as realistic as possible for the comparison. The baseline experiment was performed with three identical trucks as the agents, whereas the Q-Learning solution had two identical trucks and one slower truck. The baseline experiment was conducted using the same grade distribution as the Q-Learning model, except no material identification was performed at the shovels. Trucks were dispatched to either the mill or dump blindly based on the known material grade distribution regardless of the actual material grade in the truck bed. Considerations for queue forming were ignored, and all three agents followed a set maintenance schedule. Due to map configuration and scale limitations, this was as close to current dispatch strategies that could be reasonably created.

### Results

Results are reported according to categories presented as mistake plots, maintenance plots, and delivery frequency plots.

### Mistake Plots

Mistake plots show the cumulative number of each mistake type against the period number. Three types of mistakes were recorded across all configurations and one additional type of mistake only used in multi-agent scenarios. A delivery mistake occurred when a payload was driven further away from the proper drop-off or when material was dumped at the wrong location. A full at shovel mistake occurred when an agent with an already full payload drove back to a shovel unnecessarily, disrupting loading and traffic flow. A repair mistake occurred when an agent drove with negative health or had a repair done too early. For the multi-agent configuration, a same location mistake occurred when at least one other agent was present at the same location creating a queue.

Because of the complexity and limitations of the modelled scenario, it was sometimes not possible to avoid making a mistake, and the agent then must decide which mistake would be most desirable compared to the others. It was also possible for every type of mistake or a combination thereof to be made in one action. This means that all mistakes were not treated equally, just as they would be in a real mine. For example, creating a queue at the correct ramp for the current material is more desirable than driving the material to the incorrect ramp with no queue. In general, the relative hierarchy of mistakes from worst to best was set as follows: delivery mistake and full at shovel mistake were the same (the magnitude of the mistake depends on each individual scenario), repair mistake, same location mistake.

A second type of mistake plot shows the frequency of mistakes being made during a range of periods. Bins of various sizes were chosen to show a discretized representation of mistakes. The plots compare relative frequencies of mistakes to further illustrate the learning behaviours over time. By plotting mistake frequencies in this manner, it becomes easier to see trends in mistake making.

### Mistake Plots: Single Agent

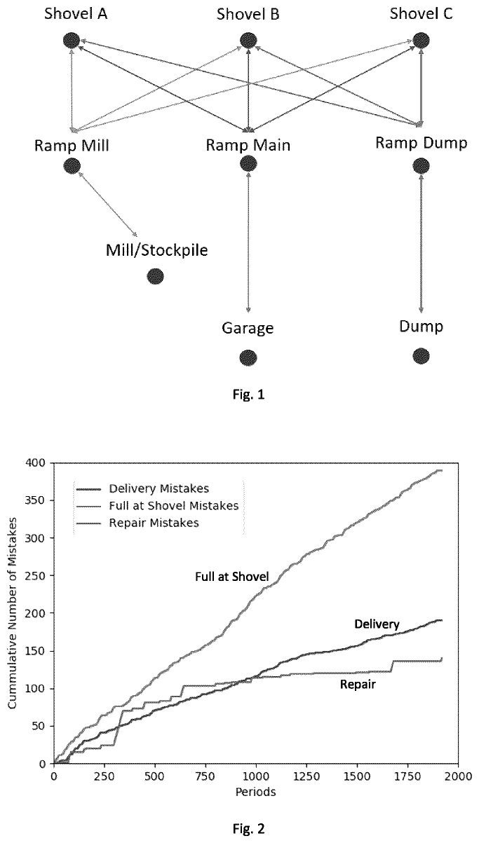

FIG. 2 is an initial mistake plot of a single agent in simulation. After the first 88 periods of exploration, the number of mistakes begins to decrease as fewer random actions are made. The repair mistake curve here shows the agent is learning how to act at different states of repair. The steep increase after 250 periods happened because the agent's health dropped below zero and it repeatedly made mistakes trying to find the garage for repairs. As time progressed, steep increases in the repair curve became less frequent, and the agent could address repair needs faster.

After one round of initial training there was a marked reduction in mistakes in all three categories.

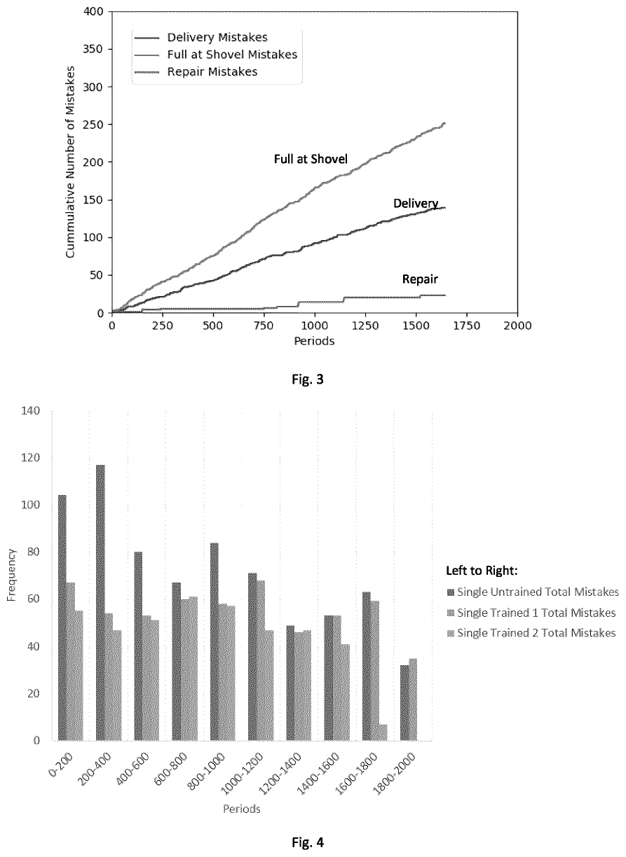

After two training rounds there was further improvement across all three categories, as shown in FIG. 3. The category that improved the most was repair mistakes, indicating that by this point, the maintenance needs can be managed by the system. The improvement of delivery mistakes and full at shovel mistakes is not as dramatic, but nevertheless the slopes of these plots are decreasing over time and slowly achieving convergence.

FIG. 4 shows that the frequency of mistakes decreased with each subsequent round of training, confirming that the system is learning. Bins of 200 periods were used to show a discretized representation of mistakes. The trend of mistake reduction is most significant from the untrained version of the model, the version with one round of training.

Based on these results, it was evident that two rounds of training increased robustness and was used as the starting point for each agent of the model in the multi-agent configuration.

Mistake Plots: Multi-Agent with No Training

FIG. 5 shows mistakes as an example of system performance for the three agents (one real and two simulated) without any pretraining. During the first 88 periods the exploration rate was at its highest, and delivery mistakes and full at shovel mistakes increased at a nearly 1:1 rate. After the exploration period was over, delivery mistakes begin to decrease, but location mistakes and full at shovel mistakes change negligibly. This means that during any given period, at least one agent is making at least one mistake. The repair mistakes lag behind the others because it takes longer for the maintenance state to affect the entire system.

FIG. 6 is a mistake frequency plot that compares the frequency of total mistakes made by the untrained model to the model with initial training. It shows that the frequency of mistakes made is substantially lower by providing initial training to the Q-table. Even during the initial 88 periods of heightened exploration, where random actions are more likely to occur, the pretrained model performs significantly better.

Mistake Plots: Multi-Agent with Single Agent Initial Training

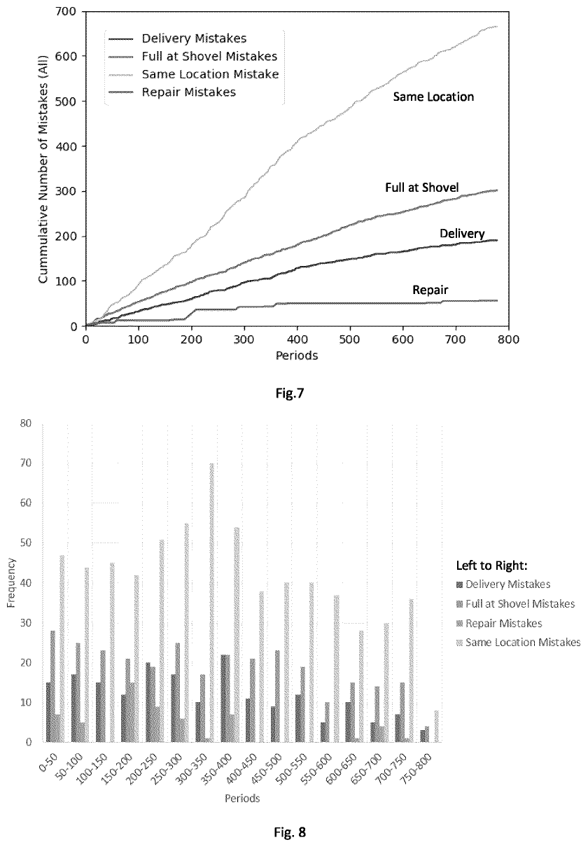

FIG. 7 is a mistake plot for a fleet of three agents working together with the same starting baseline from three simulated single agent training rounds. The slopes of the curves decrease over time as the system approaches convergence and optimization. It will be appreciated that perfect convergence for all four plots is not possible, since, in many cases, it is impossible not to make a mistake. However, the decrease in mistakes is an indicator that the algorithm learns and can adapt quickly to unexpected changes without human intervention. Further, the fact that the fleet is heterogeneous (with one agent intentionally mimicking a truck with lower performance than the other two) confirms that the system can accommodate this situation and still manages to optimize and adapt, demonstrating that the system is robust.

FIG. 8 shows the frequency of each category of mistake made by the pretrained system. With the exception of same location mistakes, the frequency of mistakes occurring across categories trends downward over time. The same location mistakes do not follow the same behaviour. This occurs for a number of reasons. Firstly, because the hierarchy of the mistake categories ranks the same location mistakes the lowest, more focus is placed on reducing the other categories. Secondly, as the agents learn how to deliver material more efficiently, there is an increased likelihood of three agents being in the same location instead of one or two because the material is being delivered properly more often. Thirdly, whereas each agent would record a mistake individually, once queues become longer, the number of same location mistakes will increase more quickly. Fourth, each agent's Q-table has a different index based on how many other agents are present at its same location. In this case, the section of the Q-table representing two additional agents present at the same current location has not been fully explored after the increased exploration period has ended. In this case, agents will not have the foresight to anticipate a negative reward when that state is achieved. Since the agent has not experienced this state often enough, it will learn later in the experiment causing the temporary increase in frequency, as seen between periods 250 and 400. Lastly, between periods 300 and 350, there are few repair and delivery mistakes. This means that the agents were delivering payloads properly and not pausing for repairs during this time, creating a scenario where there will be more overlap of agents. Even with all these challenges, after 350 periods, the system learned to avoid the long queues more often.

It will be appreciated that the system behaviour regarding same location mistakes, and/or any of the other mistakes, can be changed by appropriate adjustments of the model. Such adjustments may be desirable when adapting the model to other applications.

### Maintenance Plots

Maintenance plots show an agent's health at the time of repair with respect to set bounds (dashed lines) for scheduled maintenance with a 10% buffer to accommodate random health drops, queue avoidance delays, and to be more realistic to real-life maintenance scenarios.

### Maintenance Plots: Single Agent

In a simulation with no baseline training the agent explored different maintenance states searching for the ideal scheduled maintenance time, resulting in significant overshoot and undershoot of the maintenance bounds. By about 600 periods, there was evidence that the ideal range had been identified.

After one round of training the overshoot and undershoot of the maintenance bounds were significantly reduced, with most maintenance falling closely within the scheduled bounds. After two rounds of training the regularity of maintenance became more predictable, with only two instances post initial exploration, at roughly 200 and 800 periods, where a random action caused an early repair. However, every other repair fell within or close to the predetermined bounds. The regularity is beneficial for increased predictability and to help with supply chain and employee considerations.

### Maintenance Plots: Multi-Agent

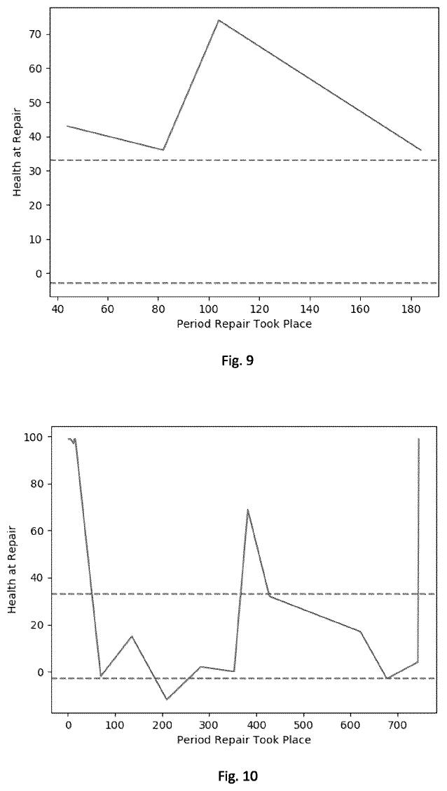

Maintenance plots for the three agents with no training showed that the system was unable to manage the maintenance across all three agents with no initial training. None of the agents were able to refine their trial and error search to find the reward. As an example, FIG. 9 is a maintenance plot for Jackal 1 in the muti-agent system with no training.

There was a dramatic improvement in maintenance of all three agents with two rounds of training, with outlying repairs being the result of random actions. As an example, FIG. 10 is a maintenance plot for Jackal 1 with two rounds of training (compare with FIG. 9).

### Delivery Frequency

### Single Agent

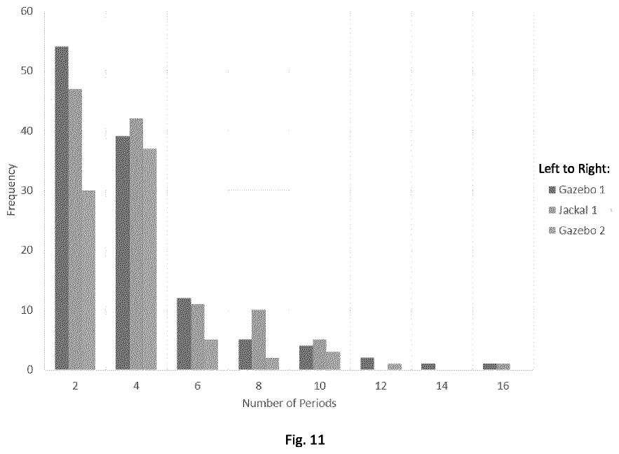

FIG. 11 and Table 4 show the performance of a single agent untrained and after one and two rounds of training. FIG. 11 shows frequency of correctly delivered payloads, wherein training improved delivery and over time the model learned to correctly deliver payloads based on material classification, and when an error was made in the delivery process the agent was able to correctly respond and correct its mistake rather than deliver the payload to the wrong location. After each round of training the range of delivery duration became smaller, with all delivery durations longer than 20 periods only occurring with the untrained agent, and with two rounds of initial training only one payload was delivered in longer than 12 periods.

Table 4 shows that with each subsequent round of training the system's performance increased. Since each test ran for a different number of periods, metrics for even comparison were made; correct payloads delivered per period and the percentage of payloads that were delivered incorrectly. As the agent learns more about its environment its performance increases across both metrics. What effects these metrics the most is the agent's ability to manage its maintenance schedule. If it drives to the garage for repairs more frequently, the number of payloads able to be delivered decreases and it increases the length of delivery for some payloads. By the second round of training, repairs follow a more predictable pattern (as noted above), and therefore the performance of Trained 2 is better.

TABLE 4
Delivery Data Analysis for a Single Agent

| Metric | Untrained | Trained 1 | Trained 2 |
|---|---|---|---|
| Number of Periods | 1920 | 1930 | 1643 |
| Total: Correct Payloads | 251 | 286 | 255 |
| Total: Incorrect Payloads | — | 15 | 5 |
| Correct Payloads | 0.131 | 0.148 | 0.155 |
| Delivered per Period | | | |
| Percentage of Payloads | — | 4.983% | 1.923% |
| Delivered Incorrectly | | | |

### Multi-Agent

Table 5 presents performance metrics for the untrained system. Although this experiment ran for less than a quarter of the time of the trained version, it is clear from both performance metrics and the number of incorrect deliveries that the system not able to learn effectively. This may be due to the large size of the Q-table for this configuration and without pre-training at least some of the tasks, it would take an extended amount of time to perform adequately.

TABLE 5
Delivery Data Analysis for the Multi-Agent Untrained Example

| Metric | Gazebo 1 | Jackal 1 | Gazebo 2 |
|---|---|---|---|
| Number of Periods | 218 | 208 | 143 |
| Total: Correct Payloads | 2 | 3 | 1 |
| Total: Incorrect Payloads | 7 | 3 | 4 |
| Correct Payloads | 0.009 | 0.014 | 0.007 |
| Delivered per Period | | | |
| Percentage of Payloads | 77.778% | 50.000% | 80.000% |
| Delivered Incorrectly | | | |

FIG. 11 and Table 6 show performance of the three agent fleet with initial training from a single agent. It can be seen that the most properly delivered payloads were delivered in either 2 or 4 periods. Interestingly, from Table 6 it can be seen that neither correct payloads delivered per period nor percentage of payloads delivered incorrectly were significantly affected by having all three agents in the system, with performance almost the same as the double trained single agent. It is also important to consider that for each agent, at least half of the incorrectly delivered payloads occurred during exploration, and the remaining were done shortly after, as each agent needed to learn that delivering a payload incorrectly was a worse choice than forming a queue at the proper ramp or delivery location.

Given the above considerations, the complete system performed very well, confirming that pretraining was beneficial to the system by breaking down the tasks, and that a dimensionally complex Q-Learning algorithm can effectively manage the fleet dispatch.

TABLE 6
Delivery Data Analysis for the Pretrained Multi-Agent System

| Metric | Gazebo 1 | Jackal 1 | Gazebo 2 |
|---|---|---|---|
| Number of Periods | 778 | 766 | 524 |
| Total: Correct Payloads | 118 | 116 | 78 |
| Total: Incorrect Payloads | 4 | 4 | 4 |
| Correct Payloads | 0.152 | 0.151 | 0.149 |
| Delivered per Period | | | |
| Percentage of Payloads | 3.279% | 3.333% | 4.878% |
| Delivered Incorrectly | | | |

### Baseline Comparison

Table 7 compares the delivery metrics of the baseline multi-agent fleet without any AI dispatching compared to the pretrained Q-Learning multi-agent fleet across the same number of periods. The baseline used three identical agents whereas the Q-Learning model had one different (poorer performing) agent. From the table it can be seen that while the baseline delivered many more payloads in the same number of periods, over 50% were delivered to the wrong location. This occurred because the baseline agents blindly deliver payloads to assigned locations regardless of what type of material is carried and they do not waste moves to make corrections. It can also be seen, even though more payloads overall were delivered by the baseline, that correct payloads delivered per period was lower, meaning that with Q-Learning payloads were delivered correctly faster than blindly delivering material. Overall the Q-Learning model based on these metrics performed considerably better than the baseline, demonstrating the value of using AI in dispatching.

TABLE 7
Comparison of baseline and pretrained Q-Learning models

| Metric | Baseline | Q-Learning |
|---|---|---|
| Number of Periods | 778 | 778 |
| Total: Correct Payloads | 273 | 312 |
| Total: Incorrect Payloads | 288 | 12 |
| Correct Payloads | 0.351 | 0.401 |
| Delivered per Period | | |
| Percentage of Payloads | 51.337% | 3.704% |
| Delivered Incorrectly | | |

### Key Performance Indicator Analysis

Key performance indicators (KPI) are used in industry as standard performance measures for equipment performance and maintenance metrics. These indicators act as “rules-of-thumb” and for an industry such as mining they may be slightly different between mine sites, although the same general categories of KPIs are used. Three maintenance categories may be availability, utility, and mean time between failures (MTBF). For performance two categories may be percentage queue time and tonnes over up time. Availability may be defined as the amount of time equipment is able to perform its task over a defined period of time. Equation (3) shows a formula for availability. Utility may be defined as the total operating time over a defined period of time. Equation (4) shows a formula for utilization of availability. MTBF determines how frequently a piece of equipment experiences a failure. Equation (5) shows a formula for MTBF. Percentage queue time may be defined as the total time an agent is in a queue over production or ready time, as shown in Equation (6). Equation (7) shows a formula for tonnes over up time. KPIs may be used in the economic decision making process to adequately compare equipment and operator performance. Typically a single indicator trend is not used to make any final economic decisions, instead, all the KPIs are used together to get a more complete understanding before making a decision.

$$Avail . = \frac{Total Time - ( Scheduled Maintenace + Unschedule Maintenance )}{Total Time} * 100 \% \qquad ( 3 )$$

$$Utility = \frac{Operating Time}{Total Time - ( Scheduled Maintenance + Unschedul Maintenance )} * 100 \% \qquad ( 4 )$$

$$MTBF = \frac{Time - ( Schedule Maintenance + Unscheduled Maintenance}{Number of Failures} * 100 \% \qquad ( 5 )$$

$$\% Queue Time = \frac{Queue Time}{Production Time} * 100 \% \qquad ( 6 )$$

$$Tonnes / Up Time = \frac{Total Tonnage}{Up Time} \qquad ( 7 )$$

Tables 8 and 9 show how each agent performed based on KPIs. Since time was not used in these experiments, periods represent the time units. Equations (3) to (7) were used to calculate KPIs for these experiments with some adaptations to accommodate the model's limitations. A failure was considered when an agent's health dropped below zero. Scheduled maintenance was represented by a repair performed within the ideal health range and when the health was negative outside the 10% bound. Unscheduled maintenance was represented by a repair performed outside the above the ideal health range. Each repair takes four periods which is how long it takes for an agent to get back to a productive location after deciding maintenance is needed. This adjustment only applies to the KPI analysis. Operating time OT was determined according to Equation (8) where La represents the number of periods an agent was at the same location as at least one other agent in the multi-agent experiments and S represents the number of periods each agent unnecessarily went to a shovel (a full at shovel mistake). Up time is represented by any period where the agent was not at the garage location. Queue time is represented in the multi-agent experiment by a period where more than one agent was located at the same location. Production time in this example was equivalent to total time. The percent queue time KPI was not used for the single agent examples because there were no queues.

$$OT = Total Time - ( Scheduled Maintenance + Unscheduled Maintenance ) - {L}_{a} - S \qquad ( 8 )$$

TABLE 8
KPIs of Single Agent Experiments

| Agent | Availability | Utility | MTBF | Tonnes/Up Time |
|---|---|---|---|---|
| Single Untrained | 92.7% | 78.1% | 148.3 periods | 0.133 |
| Single Trained 1 | 93.0% | 78.6% | 299.0 periods | 0.159 |
| Single Trained 2 | 92.0% | 83.4% | 377.8 periods | 0.162 |

TABLE 9
KPIs of Fully Trained Multi- Agent Experiments

| Agent | Availability | Utility | MTBF | Tonnes/Up Time | Queue Time |
|---|---|---|---|---|---|
| Gazebo 1 | 93.3% | 47.8% | 726 periods | 0.159 | 33.9% |
| Jackal 1 | 92.2% | 49.6% | 706 periods | 0.160 | 32.2% |
| Gazebo 2 | 93.1% | 52.7% | 244 periods | 0.159 | 29.4% |

From Tables 8 and 9 it can be seen that all agents performed similarly in the availability category. This is because, in general, the Q-Learning algorithm managed the repair scheduling well and discouraged unnecessary repairs. Managing the maintenance well allowed all agents to perform work over 90% of the time. The single agent experiments demonstrated better performance in the utility metric because there were no other agents to interact with to create a queue at any of the locations. Gazebo 2 performed better than the other two agents in the utility because it required fewer repairs overall compared to the other two agents. However, more than half of the repairs it received were done too early. If this was the case for a real haul truck it would be an inefficient use of materials. Gazebo 2, since it had more erratic repair behaviour, also had more instances when it was repaired at a negative health value; therefore, its MTBF was higher than the others. In the single agent experiment, the MTBF increased with training, as expected, because the algorithm learned how to avoid the agent's health dropping below the acceptable bounds. It can also be seen in the single agent experiments that tonnes/up time increased with more training because the agent learned how to deliver material more efficiently over time. In the multi-agent experiment tonnes/up time was roughly equivalent to the third single agent experiment, showing that the knowledge transfer was effective. The percent queue time metric shows that roughly one-third of the time the agents were in a queue, although it is difficult to equate this metric to relative performance. Overall, the ability of a Q-Learning approach to dynamically update a dispatching plan is illustrated well by each agent's success in four of the five KPI categories.

All cited publications are incorporated herein by reference in their entirety.

### EQUIVALENTS

While the invention has been described with respect to illustrative embodiments thereof, it will be understood that various changes may be made to the embodiments without departing from the scope of the invention. Accordingly, the described embodiments are to be considered merely exemplary and the invention is not to be limited thereby.

### REFERENCES

Aguero, C. E., et al. Inside the virtual robotics challenge: Simulating real-time robotic disaster response. Automation Science and Engineering, IEEE Transactions on, 12 (2): 494-506, April 2015.
Hernandez, S. et al., Multi-master ROS systems. Technical Report IRI-TR-15-01, Institut de Robotica i Informática Industrial, CSIC-UPC, 2015.
Koenig, N., et al. Design and use paradigms for gazebo, an open-source multi-robot simulator. In IEEE/RSJ International Conference on Intelligent Robots and Systems, pages 2149-2154, Sendai, Japan, September 2004.
Moore, T. et al. A generalized extended kalman filter implementation for the robot operating system. In Emanuele Menegatti, Nathan Michael, Karsten Berns, and Hiroaki Yamaguchi, editors, Intelligent Autonomous Systems 13, pages 335-348, Cham, 2016. Springer International Publishing.
Sutton, R. S., et al. Reinforcement Learning: An Introduction. The MIT Press, second edition, 2018.
Zhang, C., et al. Dynamic dispatching for large-scale heterogeneous fleet via multi-agent deep reinforcement learning. CoRR, abs/2008.10713, 2020.

1. A method for scheduling actions of a plurality of agents in a fleet, comprising:
using sensors to obtain data corresponding to actions and at least one state of one or more agent in an environment and to obtain data corresponding to states of at least one variable within the environment;
using a processor to receive the data and execute a Q-learning algorithm, wherein the algorithm includes:
computing and assigning initial Q-values for the one or more agent, wherein:
an initial Q-value corresponding to each of one or more obtainable action-states and
an initial Q-value for the at least one state of the one or more agent are assigned non-negative values; and
an initial Q-value for an unobtainable action-state is assigned a large negative value;
implementing an exploration period comprising a selected number of actions of the one or more agent, wherein after each action is completed a reward is calculated based on the at least one state of the one or more agent and the state of the at least one variable in the environment, and the reward is used to update the Q-value corresponding to the action-state;
obtaining an optimized set of Q-values for the one or more agent after the exploration period;
applying the optimized set of Q-values to the plurality of agents in the fleet, and using sensors to obtain data corresponding to actions and at least one state of the plurality of agents in the environment and to obtain data corresponding to states of at least one variable within the environment; and
further optimizing the Q-values for the plurality of agents, wherein for each agent, after an action is completed a reward is calculated based on the at least one state of the agent and the state of the at least one variable in the environment, and the reward is used to update the Q-value corresponding to the action-state.

2. The method of claim 1, wherein the exploration period comprises randomly selected action-states and action-states of agents.

3. The method of claim 2, wherein an occurrence of randomly selected action-states is gradually reduced after the exploration period.

4. The method of claim 3, wherein the occurrence of randomly selected action-states is gradually reduced according to a decay function.

5. The method of claim 4, wherein the occurrence of randomly selected action-states is gradually reduced to a fixed probability according to the decay function.

6. The method of claim 1, wherein the initial Q-value for an obtainable action-state and the initial Q-value for the at least one state of the agent are zero.

7. The method of claim 1, comprising using a controller that communicates with the plurality of agents including receiving the sensor data from the plurality of agents and sending instructions to the plurality of agents;
identifying events associated with the data and classifying the events according to relevance to a task to be performed next by an agent;
and using the classifying to control sending the data to the controller.

8. The method of claim 1, comprising using a controller that wirelessly communicates with the plurality of agents including receiving the sensor data from the plurality of agents and sending instructions to the plurality of agents;
using separate send and receive antennas on the agents;
ranking and prioritizing the instructions sent by the controller; and
controlling data acquisition rates of one or more sensors of the plurality of agents.

9. The method of claim 1, wherein the environment is selected from a factory, industry, processing plant, mine, construction site, military operation, and a disaster zone.

10. The method of claim 1, wherein the environment is terrestrial, aerial, aquatic, marine, in space, or extra-terrestrial.

11. The method of claim 1, wherein the environment is a mine.

12. The method of claim 1, wherein the reward function includes one or more of maximizing productivity, minimizing wait time of agents, and optimizing maintenance of agents.

13. The method of claim 1, wherein the reward function includes constraints imposed by traffic patterns of agents.

14. The method of claim 11, wherein states are one or more conditions selected from: grade of material loaded, if an agent is loaded or not, current location of an agent, next destination of an agent, maintenance condition of an agent, and number of agents moving to a same location.

15. Non-transitory computer readable media for use with a processor, the computer readable media having stored thereon instructions that direct the processor to:
obtain data corresponding to actions and at least one state of one or more agent in an environment and to obtain data corresponding to states of at least one variable within the environment;
execute a Q-learning algorithm, wherein the algorithm includes:
computing and assigning initial Q-values for the one or more agent, wherein:
an initial Q-value corresponding to each of one or more obtainable action-states and
an initial Q-value for the at least one state of the one or more agent are assigned non-negative values; and
an initial Q-value for an unobtainable action-state is assigned a large negative value;
implementing an exploration period comprising a selected number of actions of the one or more agent, wherein after each action is completed a reward is calculated based on the at least one state of the one or more agent and the state of the at least one variable in the environment, and the reward is used to update the Q-value corresponding to the action-state;
obtaining an optimized set of Q-values for the one agent after the exploration period;
applying the optimized set of Q-values to the plurality of agents in the fleet, and using sensors to obtain data corresponding to actions and at least one state of the plurality of agents in the environment and to obtain data corresponding to states of at least one variable within the environment; and
further optimizing the Q-values for the plurality of agents, wherein for each agent, after an action is completed a reward is calculated based on the at least one state of the agent and the state of the at least one variable in the environment, and the reward is used to update the Q-value corresponding to the action-state.

16. The non-transitory computer readable media of claim 15, wherein the exploration period comprises randomly selected action-states and action-states of agents.

17. The non-transitory computer readable media of claim 16, wherein an occurrence of randomly selected action-states is gradually reduced after the exploration period.

18. The non-transitory computer readable media of claim 17, wherein the occurrence of randomly selected action-states is gradually reduced according to a decay function.

19. The non-transitory computer readable media of claim 18, wherein the occurrence of randomly selected action-states is gradually reduced to a fixed probability according to the decay function.

20. The non-transitory computer readable media of claim 15, wherein the initial Q-value for an obtainable action-state and the initial Q-value for the at least one state of the agent are zero.

21. The non-transitory computer readable media of claim 15, wherein the instructions direct a communications protocol of a controller with the plurality of agents;
wherein the communications protocol includes receiving the sensor data from the plurality of agents and sending instructions to the plurality of agents;
wherein events associated with the data are identified and classified according to relevance to a task to be performed next by an agent.

22. The non-transitory computer readable media of claim 15, wherein the instructions direct a wireless communications protocol of a controller with the plurality of agents;
wherein the communications protocol includes receiving the sensor data from the plurality of agents and sending instructions to the plurality of agents using separate send and receive antennas on the plurality of agents;
ranking and prioritizing the instructions sent by the controller; and
controlling data acquisition rates of one or more sensors of the plurality of agents.

23. The non-transitory computer readable media of claim 15, wherein the environment is selected from a factory, industry, processing plant, mine, construction site, military operation, and a disaster zone.

24. The non-transitory computer readable media of claim 15, wherein the environment is terrestrial, aerial, aquatic, marine, in space, or extra-terrestrial.

25. The non-transitory computer readable media of claim 15, wherein the environment is a mine.

26. The non-transitory computer readable media of claim 15, wherein the reward function includes one or more of maximizing productivity, minimizing wait time of agents, and optimizing maintenance of agents.

27. The method of claim 15, wherein the reward function includes constraints imposed by traffic patterns of agents.

28. The non-transitory computer readable media of claim 25, wherein states are one or more conditions selected from: grade of material loaded, if an agent is loaded or not, current location of an agent, next destination of an agent, maintenance condition of an agent, and number of agents moving to a same location.

29. A control system that implements the method for scheduling actions of a plurality of agents in a fleet according to claim 1.

30. A control system that implements a method for scheduling actions of a plurality of agents in a fleet, wherein the control system comprises at least one processor that executes the instructions stored on the non-transitory computer readable media according to claim 15.
